(19) United States
(12) Patent Application Publication
(10) Pub. No.: US 2004/0246908 A1
(43) Pub. Date: Dec. 9, 2004

(54) Billing method and device in a cellular packet radio-communication network

(76) Inventors: Chistian Guion, Verrieres Le Buisson (FR); Ghazi Ben Amor, Paris (FR); Alain Rhelimi, Cachan (FR)

Correspondence Address: Pehr Jansson, 7628 Parkview Circle, Austin, TX, 78731, US

(21) Appl. No.: 10/492,241

(22) PCT Filed: Oct. 9, 2002
(86) PCT No.: PCT/IB02/04144

(30) Foreign Application Priority Data
Oct. 12, 2001 (FR) 01/13217

(51) Int. Cl. H04L 12/26; H04J 3/24

(52) U.S. Cl. 370/252; 370/349

(57) ABSTRACT

This invention proposes a method to obtain the cost of transmitting a set of data from a transmitting means (3, 16) to a receiving means (2) via a network (4), wherein the receiving means (2) determines the volume of said set of data received and communicates it to a billing unit (18) so that the latter can evaluate the cost of said transmission using this information and possibly other information in its possession. This invention also concerns the systems used to implement said method especially in cellular packet radio-communication networks.

The invention concerns a method and a device for the billing of services and especially of Internet services used by a mobile telephony station in a cellular packet radio-communication network.

This invention applies to GPRS (General Packet Radio Services) cellular communication networks, EDGE (Enhanced Data rate for GSM Evolution), UMTS (Universal Mobile Telephone Standard), CDMA 95 and 2000 (Code, Division Multiple Access), WCDMA (Wideband CDMA), 3GPP (Third Generation Partnership Program—European version), 3GPP2 (North American model of 3GPP), or other.

In cellular radio-communication systems such as GSM (Global, System for Mobile Communications), the voice signals and data use the same transmission path: the infrastructure which is quite suitable for the voice signals is not fast enough for data transmission. The cellular packet radio-communication networks were therefore introduced to process data.

However, a problem arises in the cellular packet radio-communication networks when the content and volume of the data transmitted must be measured.

The rates applied to the various services, and especially the Internet services, depend on the provider, the user, various reductions or special offers available, the period during which the service is requested (peak/off peak period). In addition, the rates are likely to change at any time, depending on the market situation.

Also, the volume and the content of the data transmitted must be billed to the user customer. Unlike the GSM type switching networks, in which the measurement is carried out on the basis of the time elapsed during a connection between two points, packet switching involves direct measurement of the volume of data transmitted, i.e. more precisely the number of packets transmitted. Moreover, the packets must be allocated to a given origin, bearing in mind that several transmitters may be active simultaneously.

Consequently, billing in a packet network involves measuring instantaneously and at each connection interface of the telephony network to the Internet, the flow transmitted or received, consolidating it and evaluating it according to complex rules as seen above at a single point called a collection unit from which the bill is issued.

In case of deferred billing, although complex and heavy, billing is nevertheless feasible since the collection unit has several days or hours to make out the bill. However, when the billing procedure is carried out in real time, a much more expensive infrastructure is required.

In this context, one objective of this invention is to propose a method and a simple, low-cost device for real time billing of the services required by receiving means from transmitting means in a cellular packet radio-communication type network, Internet or other.

One objective of this invention is to propose a method and a simple, low-cost device for real time billing of the services required by a mobile radiotelephony station in a cellular packet radio-communication type network.

### ABSTRACT OF THE INVENTION

In this context, this invention proposes a method to obtain the cost of transmitting a set of data from a transmitting means to a receiving means via a network, wherein the receiving means determines the volume of said set of data received and declares it to a billing unit so that the latter can evaluate the cost of said transmission using this information and possibly other information in its possession.

This invention also concerns a system to implement said method.

### DESCRIPTION OF FIGURES

Other features and advantages of the invention will appear on reading the description which follows given for illustration and as a non-limiting example of this invention, and referring to the attached drawings in which:

FIG. 1 is a diagrammatic view of one form of realisation of the system according to the invention;

FIG. 2 is a diagram illustrating the main steps of one form of realisation of the method according to this invention;

FIG. 3 is a diagrammatic view of the system according to FIG. 1 in which the main steps of the method according to FIG. 2 are shown.

### DESCRIPTION OF ONE FORM OF REALISATION OF THE INVENTION

This invention applies, although not exclusively, to mobile telephony stations in compliance with the “GPRS” standard. It must be clearly understood however that the invention is not limited to this application alone. In particular, it may be used in other standards such as those indicated above. It can also be applied to various fields in mobile telephony, for example to the field of data packet communication networks such as the Internet, or other.

In the remainder of this document, this invention will be described and illustrated in the context of the GPRS/Internet network.

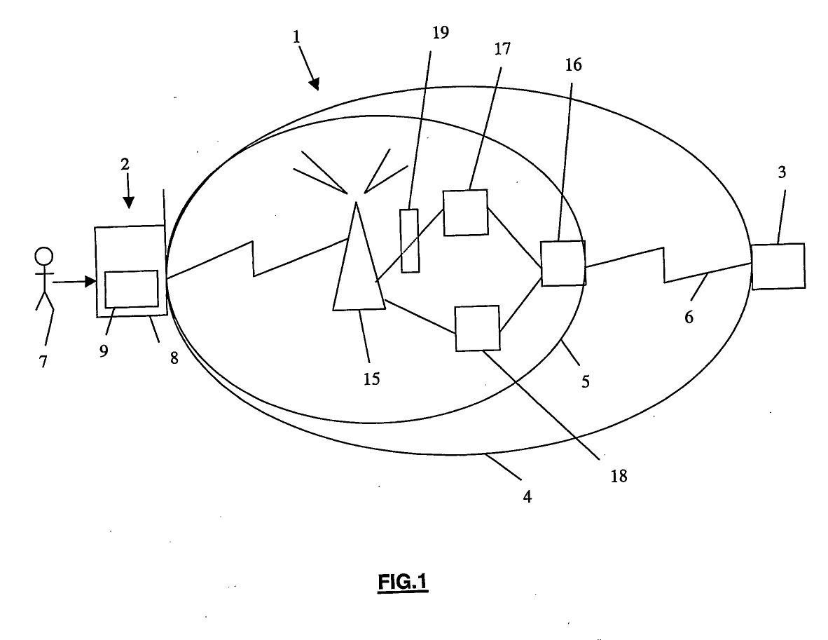

As shown in the form of realisation of the system according to the invention illustrated on FIGS. 1 and. 3, the system 1 includes receiving means 2, i.e. in the example illustrated a mobile telephony station 2 and transmitting means 3 which, in the example illustrated, are a service provider 3. The station 2 and the provider 3 are connected by a network 4.As shown on FIG. 1, the network 4 includes a GPRS network 5 and an Internet network 6.

The station 2 belongs to and is used by a user 7.The mobile telephony station 2 includes a mobile telephone 8 and a SIM card 9.

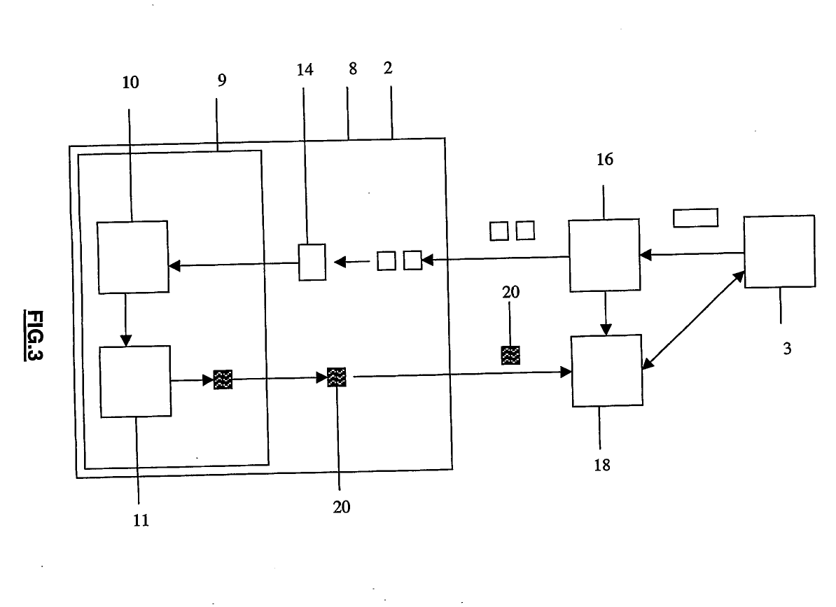

The SIM card 9 is a smartcard equipped with information processing and storage means, including a module known under the abbreviation “SIM” (Subscriber Identity Module). The SIM card stores a certain number of data items concerning the telephone subscription as such (name(s) of operator(s) that the subscription(s) have been taken out with, subscription type, subscriber identification data, etc.), as well as so-called embedded applications. In the special form of realisation illustrated on FIG. 3, the SIM card 9 includes means 10 to store information concerning the reception of data by the station 2, a cryptographic module 11 enabling said card to sign the messages which are transmitted by the SIM card.

In the remainder of the document, a subscriber card 9 is a card offering the functions of the SIM card described above. Thus, a subscriber card may also be, for example, a USIM card.

The telephone 8 and/or the subscriber card 9 include counters 14 intended to store the number of GPRS packets received, and possibly how they were received, or any other information concerning the reception of information from the GPRS network. In the form of realisation illustrated on FIG. 3, the counter is a GPRS packet counter 14 included in the telephone 8.

The GPRS network 5 includes an antenna 15 to broadcast GPRS messages, a GGSN (Gateway GPRS Support Node) module 16 acting as interface between the GPRS network and the Internet network. The GGSN module 16 is the point of access to the GPRS network for the provider 3.The module 16 can subcontract all or some of the functions assigned to it in this invention. The GGSN module 16 or any other module under its control to which it subcontracts some of its work will be hereafter referred to as unit 16. The GPRS network 5 includes several components between the antenna 15 and the GGSN module 16 such as the SGSN (Serving GPRS Support Node) modules 17 for example. Said modules 17 can act as unit 16.

The network includes a billing unit 18 connected to the unit 16 and to the station 2.

The network 4 includes limiters 19 intended to limit or interrupt the traffic to a given station 2 when certain conditions are met.

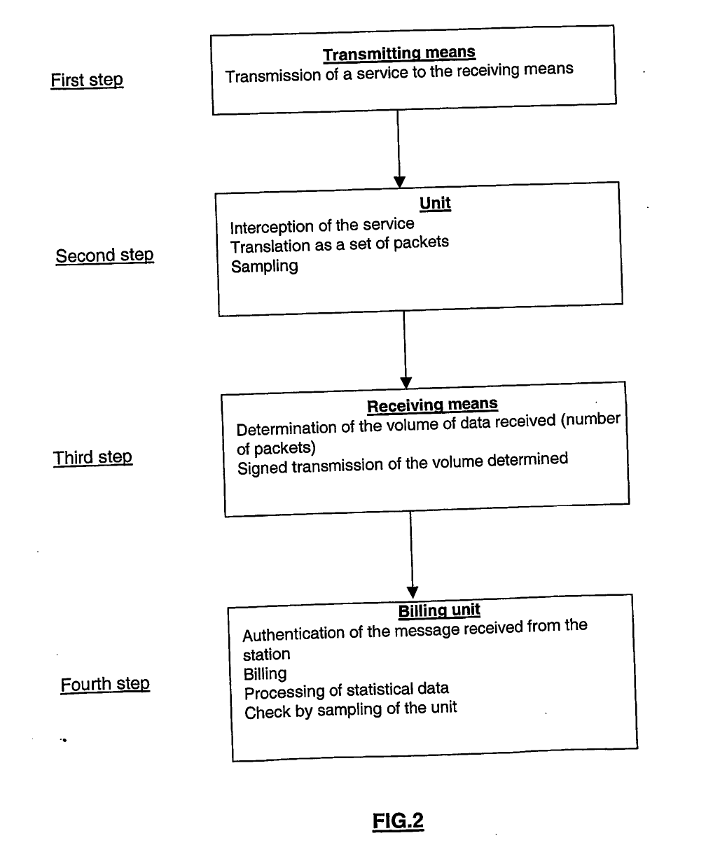

The method according to this invention illustrated on FIGS. 2 and 3 is executed as follows.

The service provider 3 transmits a service to the station 2 (First step).

The unit 16 intercepts the service and translates it into GPRS packets which it transmits to the station 2 (Second step).

The station 2 receives said GPRS packets (Third step). The telephone 8 identifies the provider 3 using the content of said packets.The packets transiting in the Internet network 6 using the TCP/IP protocol contain the sender's address; other information can be used to trace the sender such as, for example, the serial number of the IP packets in order to find the type of information transmitted by reference to predefined tables. The counter 14 of the telephone 8 or of the card 9 counts the number of packets received. If it is the counter 14 of the telephone 8, the latter communicates the number of packets counted to the subscriber card 9. The telephone 8 also communicates to the card 9 the provider's identity and the date of reception of the packets in question. The card 9 saves the number of packets received, the provider concerned, the date of reception of said packets in storage means 10. Said information can be stored as transactions (provider—date—volume—information type) in a log. It creates one or more packets 20 to be sent to the billing unit 18 containing the number of packets and possibly other information obtained by the counter or other components of the station 2 and used to produce statistics on the quality of service.

The subscriber card 9 signs the packet 20 using the cryptographic module 11. The card 9 therefore certifies said information: the card certifies that the station 2 has received a determined number of packets and also certifies the number of packets received. If the module 11 uses asymmetric cryptography, the card 9 adds a certificate to the packet 20.

The station 2 then transmits, preferably during a communication with the billing unit 18, the packet 20 that the subscriber card 9 has created and signed which contains in particular the number of packets received by the station 2. The time when the station 2 transmits said packet 20 depends on the chosen form of realisation, agreements signed between user and provider, the operator. Transmission of the packet 20 occurs for example when the number of packets received exceeds a certain threshold. According to another example, transmission occurs periodically, once a month.

The billing unit 18 (fourth step) which according to a special form of realisation can be the provider itself, authenticates the packet 20 received. The unit 18 checks that the message does come from the station 2. It replies to the station 2 by an encrypted acknowledgement which can only be detected by the subscriber card 9 concerned. The billing unit 18 knows the value of the data transmitted; it also knows the number of packets received by the station 2. Using the number of packets and their value, the billing unit 18 can obtain the cost of transmitting the packets to the station 2 and carries out the billing according to the profile of the user 7 and various rate tables stored in the unit 18.

The method is based on the communication of correct information by the station 2. However, a user could for example modify the program embedded in the station 2 in order to make false declarations to the subscriber card concerning the reception of packets.

Consequently, to limit possible frauds at the station 2, the billing unit 18 carries out sampling in the communications set up with the stations 2. The billing unit requires from each unit 16 the number of packets which it will transmit to a determined station 2 during a given period. According to another form of realisation, the unit 16 takes on its own initiative some of the traffic intended for the station 2 and sends it to the billing unit.

When the billing unit receives from the unit 16 a number of packets transmitted to the station 2 during a given period, it compares it with the number of packets declared (received and counted) by the station 2.

If the number of packets received by the station 2 is considerably less than the number of packets sent by the unit 16, the subscriber card is blocked by the operator upon request by the billing unit (instead of blocking the subscriber card, the operator may restrict the services transmitted); the acknowledgement by the billing unit expected by the subscriber card is not sent. The acceptable margin regarding the difference obtained in the number of packets is set by the operator. Above this margin, the traffic is interrupted by blocking the card.

In addition, limiters 19 may also be planned. The limiter blocks the transmission of packets to a given station 2 when the number of packets sent to it exceeds a certain threshold. A credit of time and/or volume received is allocated to the station 2; if the user exceeds his allocated credit, the limiter imposes a new transaction to receive a new credit otherwise the card will be blocked.

Lastly, if the packet 20 contains other elements on the reception of packets by the station 2 (elements obtained in particular from counters 14), the billing unit processes said elements and obtains for example an indication concerning the quality of service which it may take into consideration during the billing.

This invention concerns a method to obtain the cost of transmitting a set of data from a transmitting means 3, 16 to a receiving means 2 via a network 4, wherein the receiving means 2 determines the volume of said set of data received and declares it to a billing unit 18 so that the latter can evaluate the cost of said transmission using this information and possibly other information in its possession.

The information transmitted during said communication to the unit 18 is certified by the receiving means 2 by cryptographic signature.

The declaration of said volume by the receiving means 2 to the billing unit 18 is checked by taking samples in the data traffic transmitted to the receiving means and/or by allocating a credit of time and/or volume to the station 2.

The method is therefore based on the declaration by the receiving means. To check its declaration, it is planned over a given period to sample data sent to the receiving means 2 and to compare the volume of data transmitted with the volume of data received by said receiving means 2.

The method consists of interrupting the traffic received by said receiving means 2 when the comparison indicates a difference in volume greater than a predetermined margin.

The traffic received by said receiving means 2 is checked by a limiter 19.

This invention concerns an embedded system designed to be installed on a mobile telephony station 2, including data processing and storage means, wherein the system comprises means 10, 14 used to obtain the volume of a set of data received by said station 2 and to communicate it to a billing unit 18 so that the unit produces a bill for the data received. The system includes means 11 used to sign the information communicated to the unit 18.

This invention concerns a mobile telephone including an embedded system reader designed to receive an embedded subscriber system 4 including data processing and storage means, wherein it comprises, using a set of data received by said telephone, means to communicate to a billing unit 18 the volume of said set of data received by the telephone 3 so that the unit produces a bill for the data received.

This invention concerns the systems used to implement the methods described above and especially in the context of mobile telephony and more particularly cellular packet radio-communication networks.

1. A method to obtain the cost of transmitting a set of data from a transmitting means (3, 16) to a receiving means (2) via a network (4), wherein the receiving means (2) determines the volume of said set of data received and communicates said determined volume to a billing unit (18) so that the billing unit can evaluate the cost of said transmission using this information and possibly other information in its possession.

2. The method according to claim 1, wherein the information transmitted during said communication to the unit (18) is certified by the receiving means (2) by cryptographic signature.

3. The method according to claim 1 or 2, wherein the declaration of said volume by the receiving means (2) to the billing unit (18) is checked using at least one operation selected from the set of operations including by taking samples in the data traffic transmitted to the receiving means, by allocating a credit of time, and volume to the station (2).

4. The method according to claim 1, 2, or 3, wherein it is planned over a given period to sample data sent to the receiving means (2) and to compare the volume of data transmitted with the volume of data received by said receiving means (2).

5. The method according to claim 4, wherein it consists of interrupting the traffic received by said receiving means (2) when the comparison indicates a difference in volume greater than a predetermined margin.

6. The method according to claim 1, 2, or 3, wherein the traffic received by said receiving means (2) is checked by a limiter (19).

7. An embedded system designed to be installed on a mobile telephony station (2), including data processing and storage means, wherein the system comprises means (10, 14) used to obtain the volume of a set of data received by said station (2) and to communicate it to a billing unit (18) so that the unit produces a bill for the data received.

8. The embedded system according to claim 7, further comprising means (11) operable to sign the information communicated to the unit (18).

9. A mobile telephone including an embedded system reader designed to receive an embedded subscriber system (4) including data processing and storage means, further comprising means, from a set of data received by said telephone, to communicate to a billing unit (18) the volume of said set of data received by the telephone (3) so that the unit produces a bill for the data received.

10. The method according to claim 4, wherein the traffic received by said receiving means (2) is checked by a limiter (19).

11. The method according to claim 5, wherein the traffic received by said receiving means (2) is checked by a limiter (19).
